(19) United States
(12) Patent Application Publication
(10) Pub. No.: US 2005/0126691 A1
(43) Pub. Date: Jun. 16, 2005

(54) Transfer method and adhesive for transfer

(76) Inventor: Nobuo Sugino, Yokohama (JP)

Correspondence Address: JORDAN AND HAMBURG LLP, 122 EAST 42ND STREET, SUITE 4000, NEW YORK, NY, 10168, US

(21) Appl. No.: 10/736,185

(22) Filed: Dec. 15, 2003

(51) Int. Cl. B44C 1/165; B44C 1/00

(52) U.S. Cl. 156/230; 156/233; 156/237

(57) ABSTRACT

A transfer method is comprised of a step for applying an adhesive for transfer to an upper surface of a pattern for transfer formed on a transfer sheet, the pattern formed by copying or printing, the adhesive spreading over the upper surface of the pattern by surface tension, the adhesive for transfer being one of a hot-melt adhesive or water-soluble or alcohol soluble adhesive including acrylic pressure sensitive adhesive, polyvinyl acetate adhesive, chloroprene rubber adhesive, polyurethane resin adhesive, polyvinyl chloride adhesive, silicon rubber adhesive and the like; and a step for transferring including an over-transferring, the transferring step being performed at least one time and including removing a liner sheet after the part with the adhesive applied to it is pushed or adhered fixedly with heating on a substrate so that everyone can easily perform the transfer work and can transfer to any substrate.

### BACKGROUND OF THE INVENTION

This invention relates to a transfer method and an adhesive for transfer.

The conventional method of creating a transfer sheet by the copy machine or printer is proposed by the inventor of the present invention, the user have to transfer the transfer sheet by heating and pressing using the iron machine.

Since the conventional transfer sheet created by the copy machine and printer is transferred by using the iron machine, it cannot be used to the children who cannot use the iron machine, and the transferred object to transfer is limited.

### SUMMARY OF THE INVENTION

Accordingly, it is an object of the invention to provide a transfer method and an adhesive for transfer that everyone can perform to transfer in any transferred object simply and easily.

The lining and the board effect of the pattern for transfer etc. are achieved.

Novel features which are believed to be characteristic of the invention, both as to its organization and method of operation, together with further objects and advantages thereof, are described below with reference to the accompanying drawings in which preferred embodiments of the invention are illustrated as an example.

It is to be expressly understood, however, that the drawings are for the purpose of illustration and description only, and are not intended as a definition of the limits of the invention.

### BRIEF DESCRIPTION OF THE DRAWINGS

FIG. 1 is a flow diagram showing a first embodiment of the present invention;

FIG. 2 is an explanation view of a step for applying an adhesive for transfer showing a first embodiment of the present invention;

FIG. 3 is a plan view of a transfer sheet showing a first embodiment of the present invention;

FIG. 4 a cross sectional view taken along a line 4-4 of FIG. 3 showing a first embodiment of the present invention;

FIG. 5 is an explanation view of a step for transferring showing a first embodiment of the present invention;

FIG. 6 is a flow diagram showing a second embodiment of the present invention;

FIG. 7 is an explanation view of a step for applying an adhesive for transfer showing a second embodiment of the present invention;

FIG. 8 is an explanation view of a transfer sheet showing a second embodiment of the present invention;

FIG. 9 is a flow diagram showing a third embodiment of the present invention;

FIG. 10 is an explanation view of a step for applying an adhesive for transfer showing a third embodiment of the present invention;

FIG. 11 is an explanation view of a step for transferring showing a third embodiment of the present invention;

FIG. 12 is a flow diagram showing a fourth embodiment of the present invention;

FIG. 13 is an explanation view of a step for applying an adhesive for transfer showing a fourth embodiment of the present invention;

FIG. 14 is an explanation view of a step for transferring showing a fourth embodiment of the present invention;

FIG. 15 is a flow diagram showing a fifth embodiment of the present invention;

FIG. 16 is an explanation view of a step for transferring showing a fifth embodiment of the present invention;

FIG. 17 is an explanation view of a step for forming a coating layer showing a fifth embodiment of the present invention;

FIG. 18 is a flow diagram showing a sixth embodiment of the present invention;

FIG. 19 is an explanation view of a print sheet showing a sixth embodiment of the present invention;

FIG. 20 is an explanation view of a step for forming a transfer sheet showing a sixth embodiment of the present invention;

FIG. 21 is an explanation view of a step for transferring showing a sixth embodiment of the present invention;

FIG. 22 is a flow diagram showing a seventh embodiment of the present invention;

FIG. 23 is an explanation view of a printed sheet showing a seventh embodiment of the present invention; and

FIG. 24 is an explanation view of a step for forming a transfer sheet showing a seventh embodiment of the present invention.

### DETAILED DESCRIPTION OF TEE PREFERRED EMBODIMENTS

Preferred embodiments of the present invention are described in more detail below with reference to the accompanying drawings.

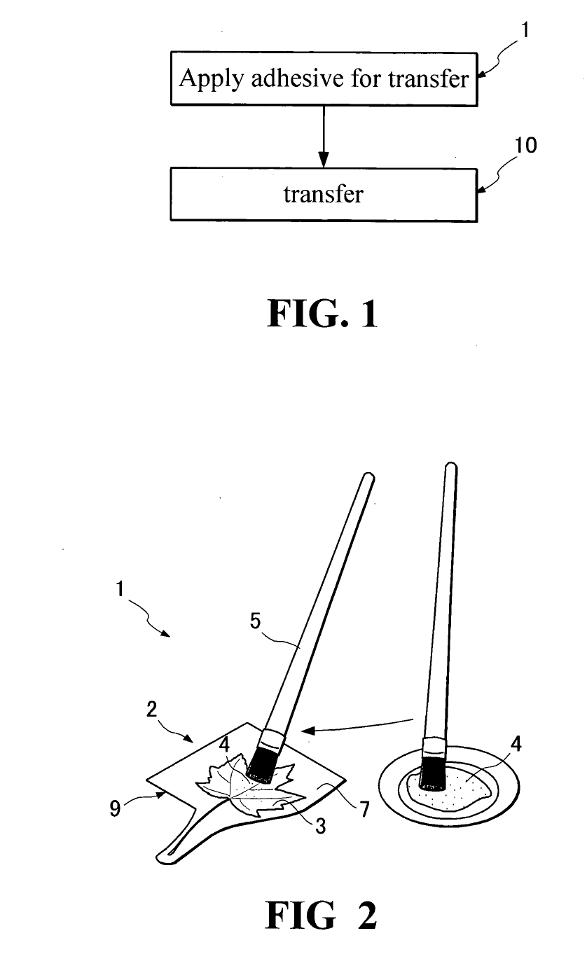

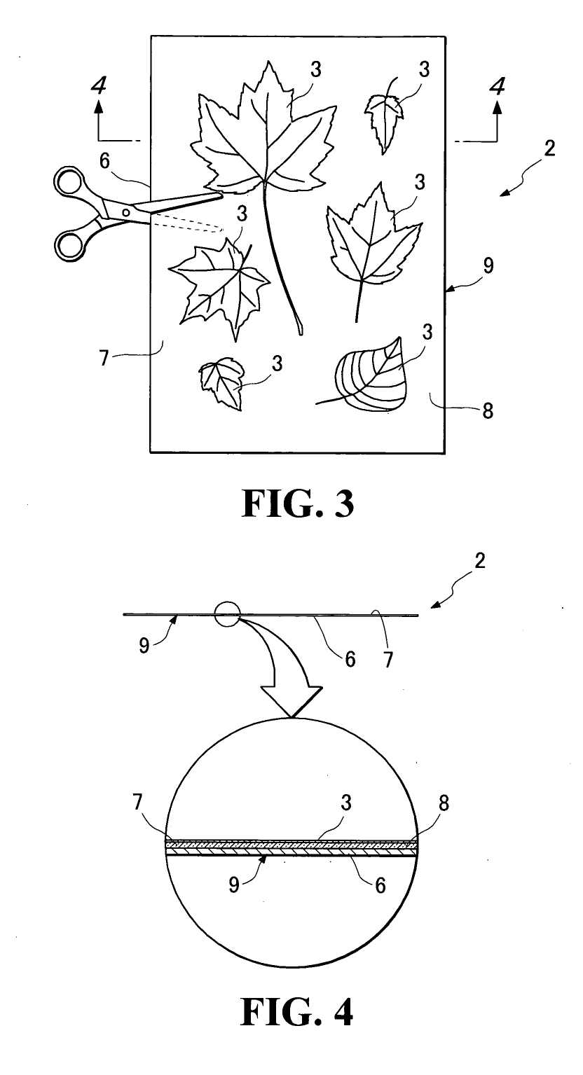

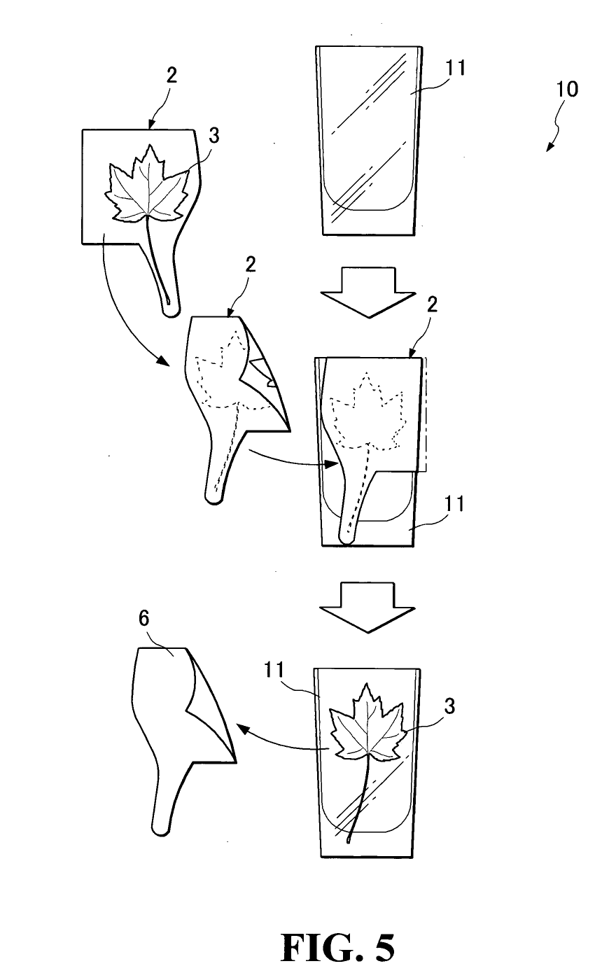

FIGS. 1-5 illustrate a transfer method and an adhesive for transfer in accordance with a first embodiment of the present invention. The numeral 1 shows a step for applying an adhesive 4 for transfer to an upper surface of a pattern 3 for transfer formed on a transfer sheet 2 by coping or printing in a brush 5 or the like. As shown in FIG. 3 and FIG. 4, the transfer sheet 2 used in the adhesive application step 1 is comprised of a copy sheet or print sheet 9 with a remover layer 8 which formed after a remover 7 is applied or adhered to a sheet 6; and the pattern 3 for transfer including the character, picture, etc. which is copied or printed, using a resin toner on the upper surface of the remover layer 8 of the copy sheet or the print sheet 9.

Moreover, the adhesive 4 for transfer is a hot-melt adhesive or water-soluble or alcohol soluble adhesive including acrylic pressure sensitive adhesive, polyvinyl acetate adhesive, chloroprene rubber adhesive, polyurethane resin adhesive, polyvinyl chloride adhesive, silicon rubber adhesive and the like. The adhesive 4 has a surface tension on the upper surface of the pattern 3 for transfer, and the surface tension of the upper surface of the pattern 3 is larger than that of water so that the adhesive 4 can move on the remover layer 8 with the surface tension.

For this reason, since the adhesive 4 for transfer is applied in the upper surface of the pattern 3 for transfer of the transfer sheet 2, the adhesive 4 applied in the remover layers 8 other than the pattern 3 for transfer moves smoothly on the upper surface of the pattern by the surface tension of this adhesive 4 for transfer and the slip of the upper surface of the remover layer 8, and it can be prevented to adhere the part other than the pattern 3 for transfer efficiently.

The numeral 10 shows a step for transferring including over-transferring. The transfer step is performed to remove the sheet 6 of the transfer sheet 2 one or more times after the part applied the adhesive 4 is pushed or adhered fixedly with heating on a transferred object 11 including a cloth, sheet, glass and a container. Although the transfer step 10 is performed once in the embodiment of present invention, it can be transferred into a curved surface portion as well as a plane surface when there is a portion that can be adhered the adhesive 4 for transfer.

Since the above-mentioned transfer method only uses the adhesive 4 for transfer, everyone can transfer easily, it can be transferred to any object and expand the range of transfer.

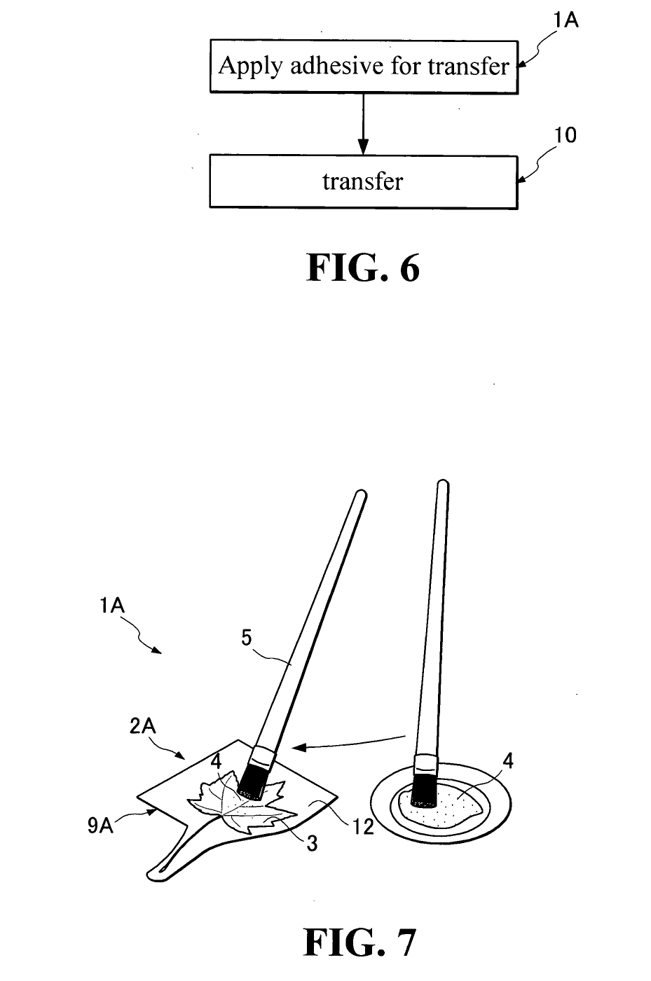

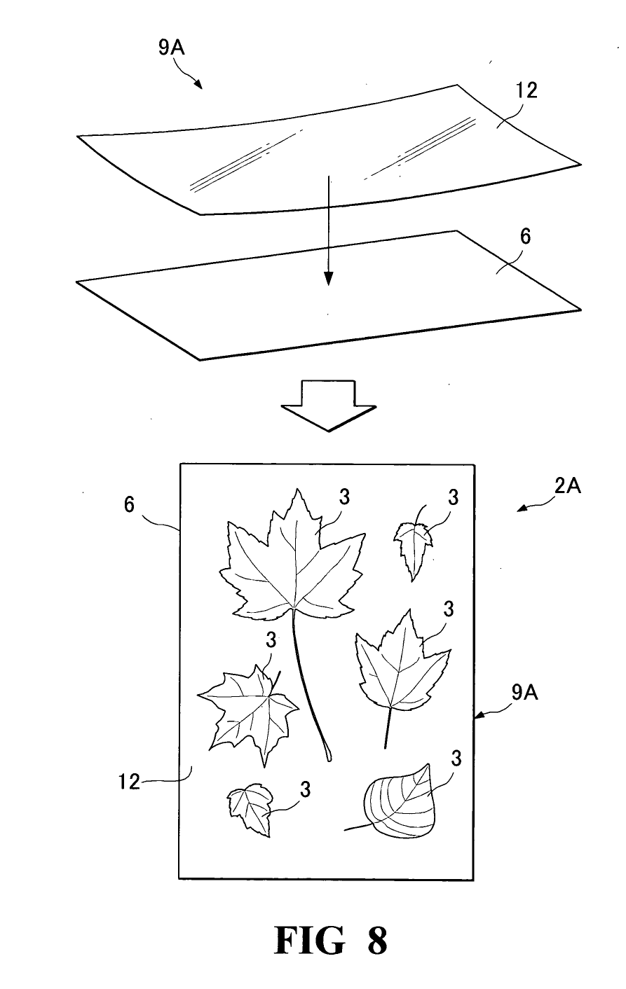

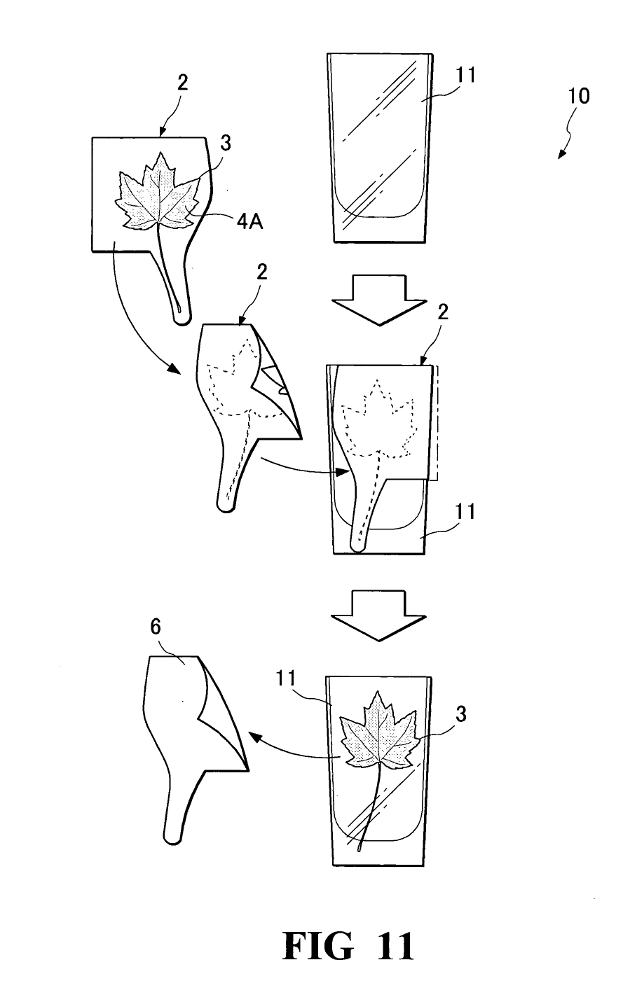

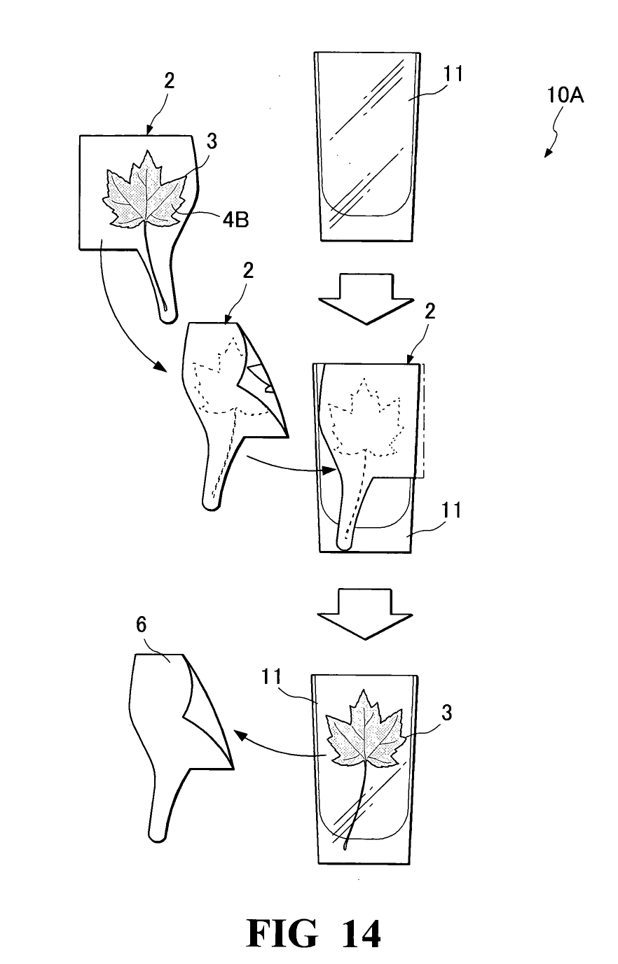

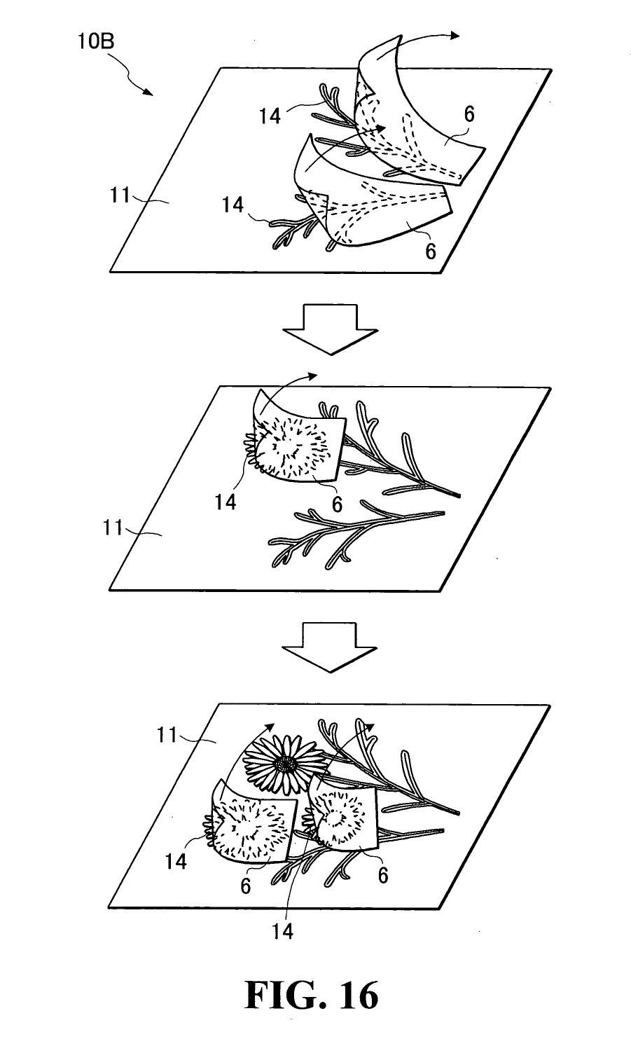

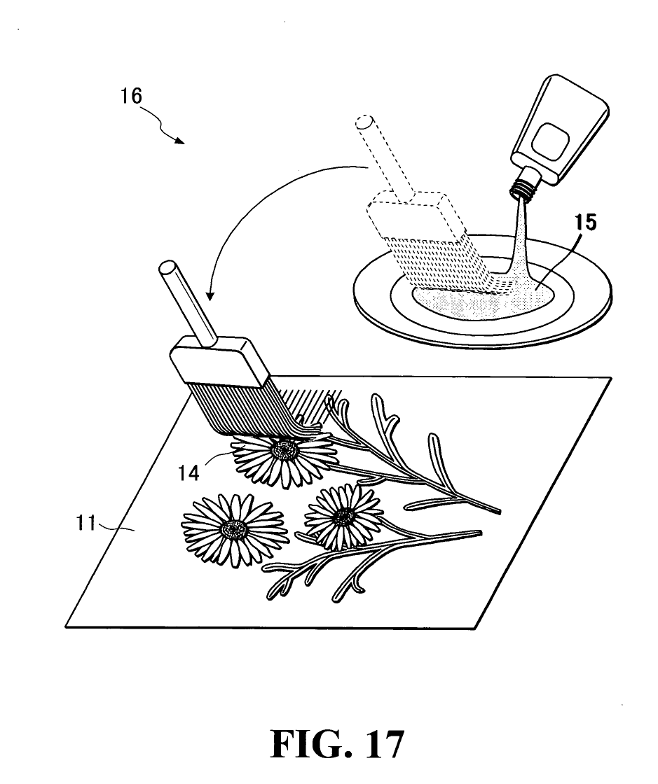

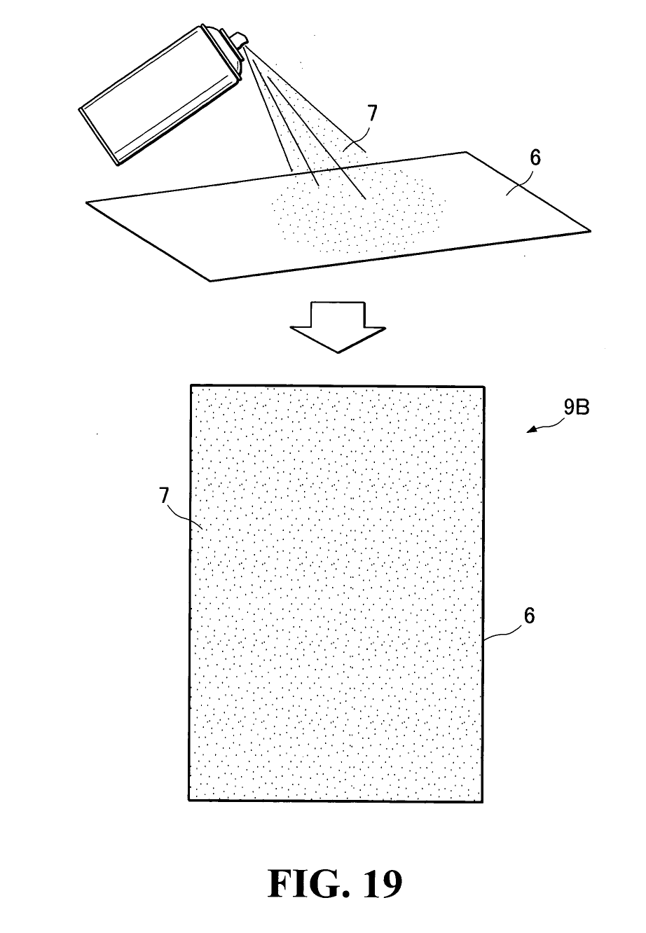

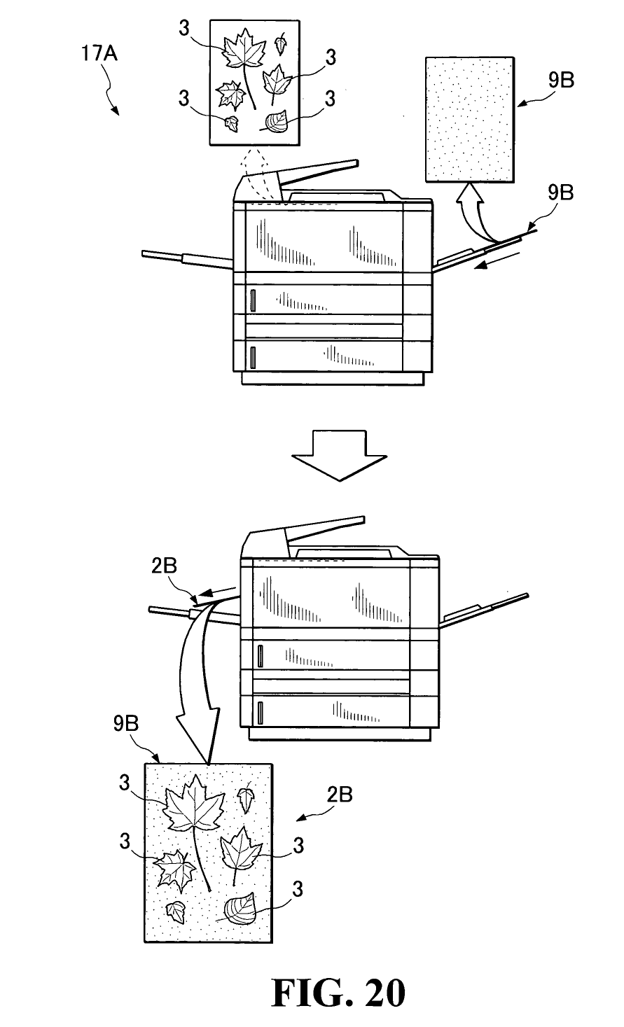

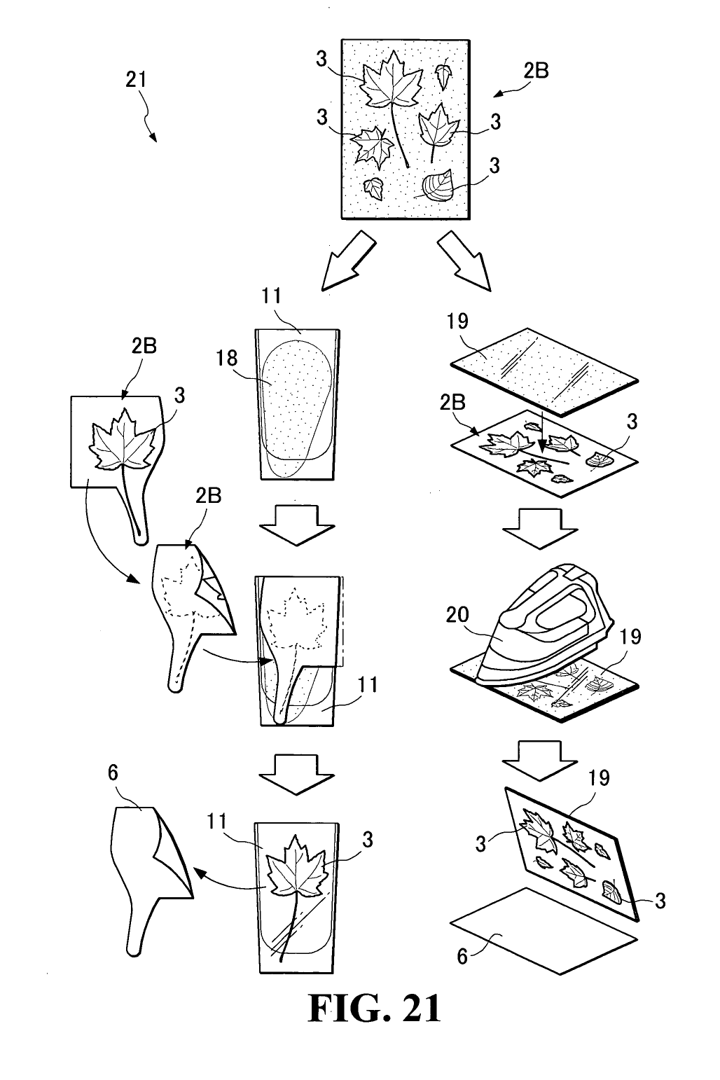

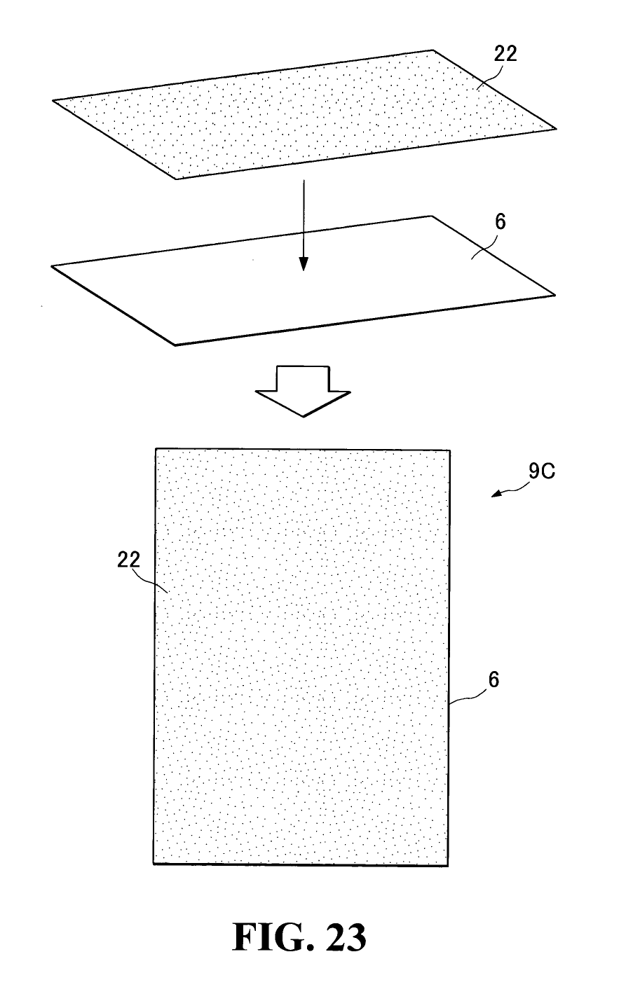

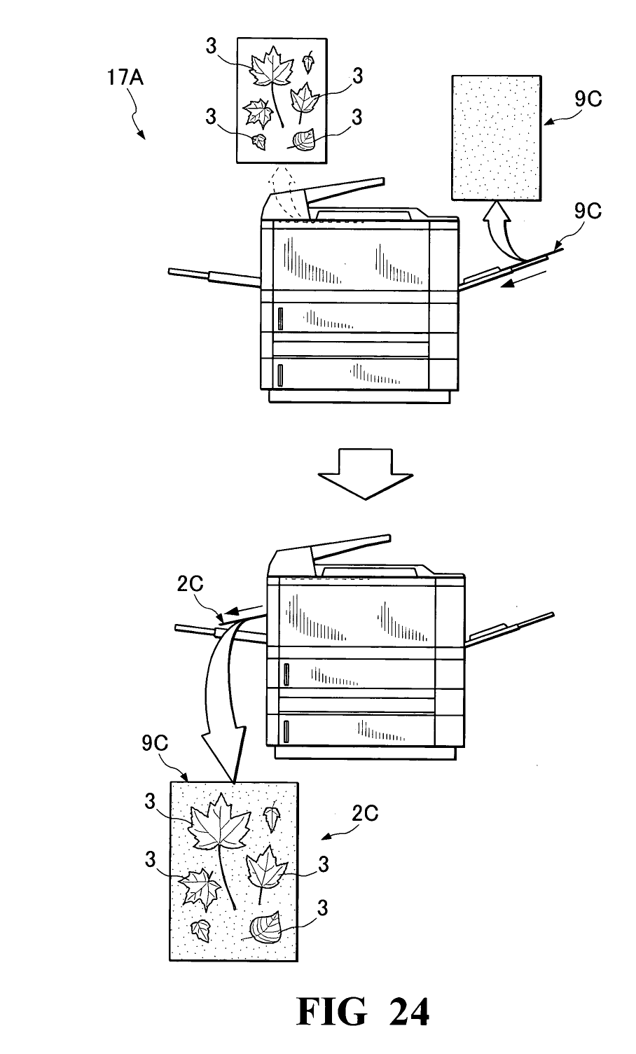

Other embodiments of the present invention will now be described with reference to FIGS. 6-24. In FIGS. 6-24, the same components as in the first embodiment described above with reference to FIGS. 6-24 are designated by the same reference numerals and therefore will not be further explained in great detail.

A second embodiment of the present invention is shown in FIGS. 6-8. It is distinguished from the first embodiment in that the transfer sheet 2 is replaced from another sheet 2A that is comprised of a copy sheet or print sheet 9A that has a remover sheet 12 as the remover layer 8; and the pattern for transfer that is copied or printed on the remove sheet 12. A transfer method with an adhesive application step 1A according to the second embodiment has similar advantages to that according to the first embodiment.

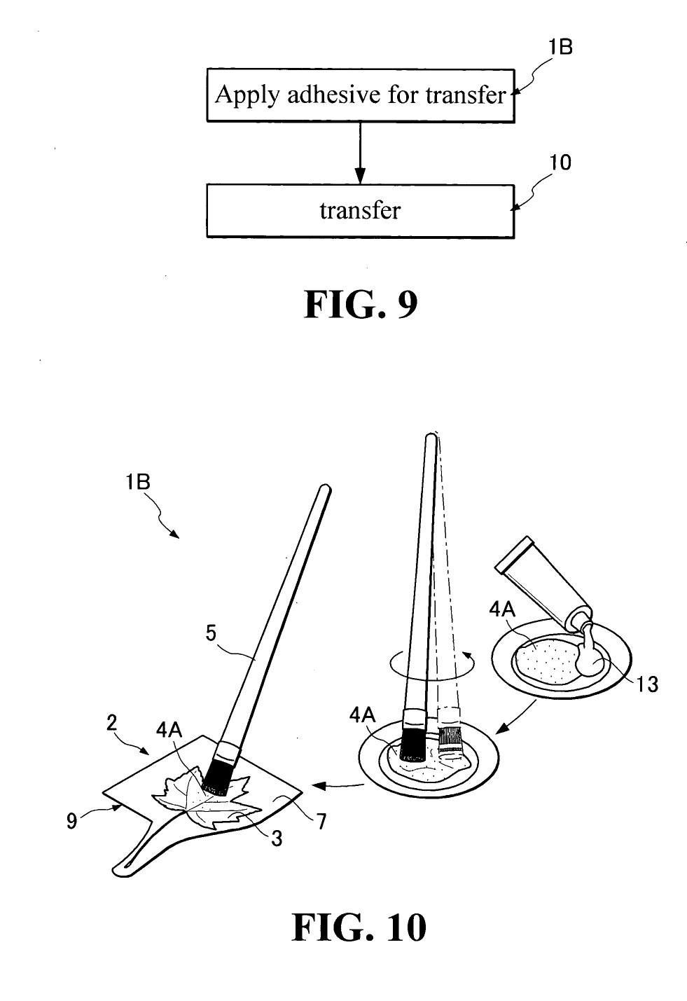

A third embodiment of the present invention is shown in FIGS. 9-11. It is distinguished from the first embodiment in that the adhesive 4 is replaced from another adhesive 4A for transfer which is the water-soluble or alcohol soluble adhesive including acrylic pressure sensitive adhesive, polyvinyl acetate adhesive, chloroprene rubber adhesive, polyurethane resin adhesive, polyvinyl chloride adhesive, silicon rubber adhesive and the like and which can be colored with a paint 13. A transfer method with an adhesive application step 1B according to the third embodiment has similar advantages to that according to the first embodiment, and the lining and the board effect are achieved for the adhesive layer formed of the application of the adhesive 4A for transfer by coloring the adhesive 4A with a paint 13.

Especially, although the color of white is not exist in the pattern 3 for transfer of the transfer sheet 2A formed by coping or printing, the fault of the transfer sheet 2A is resolved by setting white coloring to adhesive 4A for transfer.

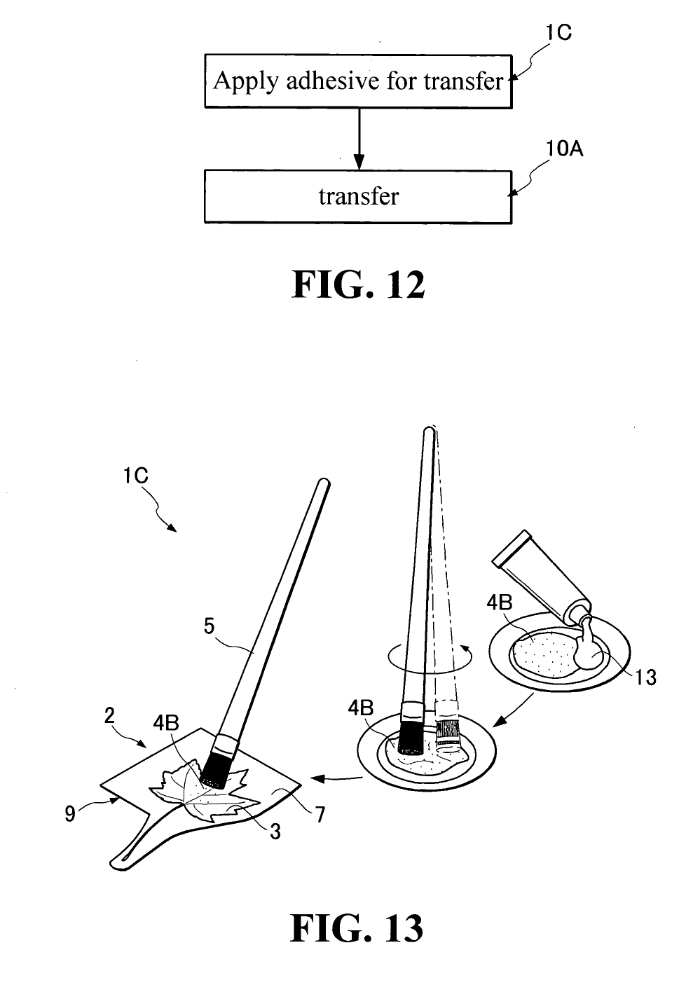

A fourth embodiment of the present invention is shown in FIGS. 12-14. It is distinguished from the second embodiment in that the adhesive application step 1A is replaced from another step 1C and the transfer step 10 is replaced from another step 10A. In the adhesive application step 1C, an adhesive 4B is applied. The adhesive 4B, with flexibility to the upper surface of the pattern for transfer of the transfer sheet 2 or the transferred surface of the transferred object 11 and staining properties which can color with paint 13, is acrylic pressure sensitive adhesive, polyvinyl acetate adhesive, chloroprene rubber adhesive, polyurethane resin adhesive, polyvinyl chloride adhesive, silicon rubber adhesive and the like. In the transfer step 10A, the sheet is removed after the part applied the adhesive 4B is pressed to the transferred object 11 or the pattern 3 for transfer of the transfer sheet 2 is adhered fixedly to the part applied the adhesive 4B of the transferred surface of the transferred object 11. A transfer method with an adhesive application step 1C according to the fourth embodiment has similar advantages to that according to the second embodiment.

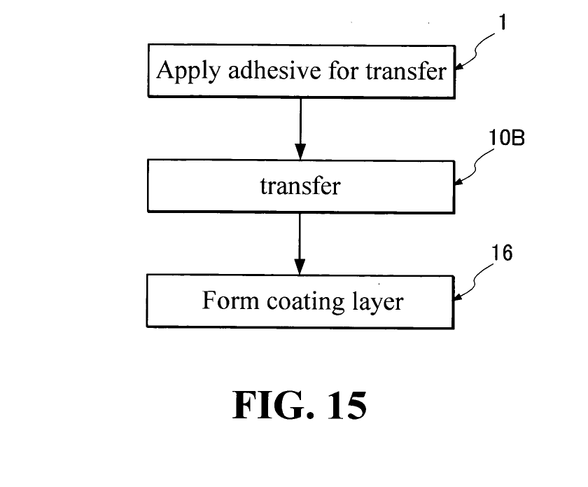

A fifth embodiment of the present invention is shown in FIGS. 15-17. It is distinguished from the first embodiment in that the transfer step 10 is replaced from another step 10B and a step 16 for forming a coating layer is performed after the transfer step 10B is carried out. In the transfer step 10B, the work which removes the sheet 6 of the transfer sheet 2 is carried out at least two times in order that a transferred picture 14 is transferred at different position each other or at overlapped position each other after the part applied the adhesive 4 is pushed or adhered fixedly with heating on a transferred object 11 including a cloth, sheet, glass and a container. In the coating layer forming step 16, a quick-drying coat liquid 15, including a top coat of the transparent or colored manicure, is formed at least one layer after the transfer step is carried out. The above-mention step according to the fifth embodiment has similar advantages to that according to the first embodiment, and it can be honed to the three-dimensional transferred picture 14, the coating layer covers the upper surface of the three-dimensional transfer picture 14 so that it can prevent certainly to discolor or damage.

In addition, the more beautiful transferred picture 14 can be created by applying the colored coat liquid 15 according to the colors of the pattern for transfer in the way of drawing a picture.

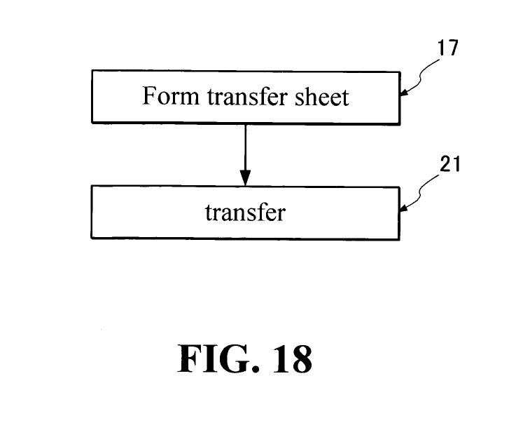

A sixth embodiment of the present invention is shown in FIGS. 18-21. It is distinguished from the first embodiment in that a step 17 for forming a transfer sheet 2B is carried out, after that, a step 21 for transferring is carried out. The transfer sheet 2B is comprised of the copy sheet or print sheet 9 with the remover layer 8 which formed after the remover 7 is applied or adhered to the sheet 6; and the pattern 3 for transfer which is copied or printed, using a resin toner on the upper surface of the remover layer 8 of the copy sheet or the print sheet 9B. In the transfer step 21, the pattern 3 or the upper surface of the pattern 3 for transfer of the transfer sheet 2B is transferred to the transferred object 11 with either adhering by transparent or semi-transparent adhesives 18 or hot-melt resin 19 or adding the heat of an iron 20. The above-mention transfer step according to the sixth embodiment has similar advantages to that according to the first embodiment.

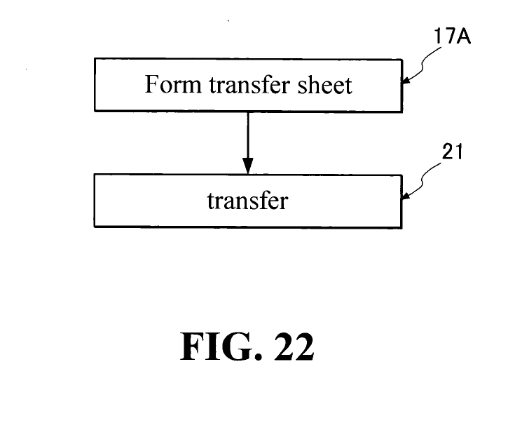

A seventh embodiment of the present invention is shown in FIGS. 22-24. It is distinguished from the sixth embodiment in that the forming step 17 is replaced from another step 17A which forms a transfer sheet 2C with the pattern 3 formed on a remover sheet 22 of the print sheet 9C adhered to the sheet 6 by coping or printing with the resin toner. The above-mention transfer step according to the seventh embodiment has similar advantages to that according to the sixth embodiment.

In the first to fourth embodiments of the present invention, the transfer step 10B or the forming step 16 of the coating layer may be carried out.

As set forth above, the advantages of the invention are as follows:

(1) The transfer method is comprised of a step for applying an adhesive for transfer to an upper surface of a pattern for transfer formed on a transfer sheet with coping or printing, moving to the upper surface of the pattern by a surface tension, the adhesive for transfer is one of a hot-melt adhesive or water-soluble or alcohol soluble adhesive including acrylic pressure sensitive adhesive, polyvinyl acetate adhesive, chloroprene rubber adhesive, polyurethane resin adhesive, polyvinyl chloride adhesive, silicon rubber adhesive and the like; and a step for transferring including an over-transferring, performing to remove a sheet at least one time or more after the part applied the adhesive is pushed or adhered fixedly with heating on a transferred object so that everyone can easily perform the transfer work since only the pattern for transfer can be transferred by the application work of the adhesive for transfer,.

Therefore, everyone can enjoy transfer freely.

(2) As discussed above, the quality of the material or form of the transferred object to transfer is not limited by the adhesive power of the adhesive for transfer, and transfer object can be transferred to any transferred object.

(3) As discussed above, the adhesive for transfer which adhered with the exception of the upper part of the pattern for transfer can be move smoothly on the pattern for transfer with surface tension etc. when the adhesive for transfer is applied to the upper part of the pattern for transfer of the transfer sheet.

Therefore, the amount of the adhesive which overflows from the pattern for transfer can be reduced remarkably, and the pattern can be transferred finely.

(4) As discussed above, the three-dimensional transferred picture can be created by the over-transferring is performed at the transfer step.

(5) Also claim 2 achieves with the same effect as the above (1) to (4), and the lining and board effect are achieved by the adhesive for transfer colored with paints. (6) Also claim 7 is acquired with the same action and effect as the above (1) to (4). (7) Also claim 10 is acquired with the same action and effect as the above (1) to (4), and the coating layer can cover the transferred picture, and it can prevent certainly to discolor or damage.

1. A transfer method comprising:
applying an adhesive to an upper surface of a pattern the pattern having been formed on a transfer sheet by copying or printing, the adhesive and pattern adapted such that the surface tension of the adhesive allows it to spread on the upper surface of the pattern the adhesive being one of a hot-melt adhesive, water-soluble, and alcohol soluble adhesive including acrylic pressure sensitive adhesive, polyvinyl acetate adhesive, chloroprene rubber adhesive, polyurethane resin adhesive, polyvinyl chloride adhesive, and silicon rubber adhesive and
transferring the pattern to a substrate by applying pressure or heat, wherein one or more patterns can be transferred on a substrate and wherein the patterns are adapted to be able to overlay on one another on the substrate.

2. The transfer method according to claim 1 wherein the adhesive is one of a water-soluble and alcohol soluble adhesive including acrylic pressure sensitive adhesive, polyvinyl acetate adhesive, chloroprene rubber adhesive, polyurethane resin adhesive, polyvinyl chloride adhesive, and silicon rubber adhesive wherein the adhesive is adapted to be capable of being colored by paint.

3. A transfer method according to claim 1 or 2, further comprising:
forming one or more coating layers on the transferred patterns after the transfer step is carried out, wherein the one or more coating layers are one of a transparent and a colored coating liquid.

4. A transfer method according to claim 1 or 2, wherein the transfer sheet comprises:
one of a copy sheet and print sheet, the print sheet and copy sheet comprising removal sheet as a remover layer and a liner sheet and
a pattern for transfer which is copied or printed on the removal sheet of one of the copy sheet and the print sheet.

5. A transfer method according to claim 4, wherein the remover layer of the transfer sheet is formed by applying a remover to the liner sheet.

6. (canceled)

7. A transfer method comprising:
forming a transfer sheet with a pattern, the pattern being formed by one of copying and printing on a remover layer, the remover layer being on a liner sheet, and
transferring the pattern wherein one or more patterns can be transferred on a substrate and wherein the patterns are adapted to be able to overlay on one another on the substrate, and wherein the transferring comprises one of adhering with transparent or semi-transparent adhesives by using pressure and adhering with a hot-melt resin by adding the heat of an iron.

8. A transfer method according to claim 7, wherein the remover layer of the transfer sheet is formed by applying a remover to the liner sheet.

9. (canceled)

10. A transfer method comprising:
forming a transfer sheet with a pattern formed by copying or printing the pattern on a remover layer of the transfer sheet, the transfer sheet comprising a remover layer on a of a liner sheet; and
applying an adhesive to one of an upper surface of a pattern for transfer formed on a transfer sheet and a transfer surface of a substrate, the adhesive for transfer being one of an acrylic pressure sensitive adhesive, polyvinyl acetate adhesive, chloroprene rubber adhesive, polyurethane resin adhesive, polyvinyl chloride adhesive and silicon rubber adhesive, the adhesive having flexibility and staining properties; and
transferring one or more patterns onto a substrate, the patterns being adapted to be able to overlay on one another on the substrate, and wherein the pattern with the adhesive is applied onto the substrate or the pattern without adhesive is applied onto the portion of the substrate having adhesive.

11. A transfer method according to claim 10, wherein the remover layer of the transfer sheet is formed by applying a remover to the liner sheet.

12. (canceled)
